(19) United States
(12) Patent Application Publication
(10) Pub. No.: US 2014/0342262 A1
(43) Pub. Date: Nov. 20, 2014

(54) Fuel Cell

(71) Applicant: UCL BUSINESS PLC, London Greater London (GB)

(72) Inventors: Daniel Brett, Gerrards Cross Buckinghamshire (GB); Christopher Gibbs, Mildenhall (GB); Rhodri Jervis, London Greater London (GB); Noramalina Mansor, London Greater London (GB)

(73) Assignee: UCL BUSINESS PLC, London Greater London (GB)

(21) Appl. No.: 14/367,645

(22) PCT Filed: Dec. 18, 2012
(86) PCT No.: PCT/GB2012/053175

§ 371 Date: Jun. 20, 2014

(30) Foreign Application Priority Data
Dec. 20, 2011 (GB) 1121898.9

(51) Int. Cl. H01M 4/92; H01M 8/22; H01M 8/24

(52) U.S. Cl. CPC H01M 4/921; H01M 8/24; H01M 8/22; H01M 2250/00
USPC 429/452; 429/525

(57) ABSTRACT

The present invention relates to a hydrogen, methanol, or ethanol fuel cell comprising an anode electrocatalyst comprising palladium and iridium, and relates to a fuel cell stack comprising said fuel cell. The invention also relates to a method of making a fuel cell. The invention also relates to the use of the anode electrocatalyst in a hydrogen, methanol or ethanol fuel cell.

### FIELD OF THE INVENTION

The present invention relates to a hydrogen, methanol or ethanol fuel cell, and relates to a fuel cell stack comprising the same. The invention also relates to a method of making a fuel cell.

### BACKGROUND OF THE INVENTION

A fuel cell is an electrochemical cell comprising two electrodes (anode and cathode) separated by an electrolyte. Fuel (e.g. hydrogen, any gas mixture containing hydrogen, or methanol, ethanol, and other short chain alcohols) is supplied to the anode while an oxidant (e.g. pure oxygen or air) is supplied to the cathode. Electrochemical reactions occur at each electrode, and the chemical energy of the fuel is converted into heat, electricity, and water. Electrocatalysts at the electrodes promote the kinetics of each chemical reaction in order to produce electricity at a significant rate for practical applications.

Fuel cells which employ a polymeric electrolyte are collectively described as polymer electrolyte fuel cells. This category is subdivided into two additional types of fuel cell: proton exchange membrane fuel cells and anion exchange membrane fuel cells. In the proton exchange membrane (PEM) fuel cell, an acidic polymer membrane separates the electrodes. The acidic polymer allows the transport of protons (hydrogen ions) between the electrodes but is not electrically conductive. An example of a commonly used acidic polymer electrolyte is Nafion® (Du Pont De Nemours). Other examples of proton exchange membranes include a class of high temperature membranes based on polybenzimidazole (PBI) chemistry (e.g. PBI as a matrix doped with acid is described in Samms S R, et al. J Electrochem. Soc. Vol 143, Issue 4 (1996) pp 1225-1232; sulfonated PBI chemistry is described in Staiti P. et al, “Sulfonated polybenzimidazole membranes—preparation and physio-chemical characterization” Journal of Membrane Science, Vol 188, Issue 1, (2001) pp 71-78). In the anion exchange membrane (AEM) fuel cell, an alkaline polymer is employed. The alkaline polymer allows the transport of hydroxide ions between the electrodes. Examples of a commonly used alkaline polymer electrolyte are Morgane®-ADP (Solvay S A, Belgium) and A-006 (Tokoyama Corporation, Japan), or partially fluorinated radiation grafted membranes with trimethylammonium headgroup chemistry (Varcoe, et al. Solid State Ionics 176 (2005) 585-597).

Not all fuel cells employ a polymeric membrane or ionomer promoting the conduction of electrons. Liquid electrolyte systems also exist in the context of both acidic and alkaline fuel cells. For the acidic environments, the phosphoric acid fuel cell is an exemplary example of a liquid electrolyte fuel cell.

The fuel cell need not be limited to either polymer or liquid either. Hybrid systems using some polymeric ionomer and liquid electrolyte are also possible.

The most commonly-used type of fuel cell for 100 W to 100 kW applications is the Proton Exchange Membrane (PEM) fuel cell. The electrolyte in a PEM is a solid polymer membrane. However, the PEM conducts protons produced at the anode (from hydrogen fuel) to the cathode while being electrically insulating. The protons combine with oxygen at the cathode to produce water. The anode reaction is known as the Hydrogen Oxidation Reaction (HOR). The cathode reaction is known as the Oxygen Reduction Reaction (ORR). The electrochemical reactions in a PEM or a phosphoric acid fuel cell (PAFC) where hydrogen is the fuel are given below:

Anode: 2H₂=4H⁺+4e⁻ (Reaction: HOR)

Cathode: 4H⁺+4e⁻+O₂=2H₂O (Reaction: ORR)

Overall: 2H₂+O₂+=2H₂O

In an Alkaline Anion Exchange Membrane (AAEM) the electrolyte is also a solid polymer membrane. The AAEM conducts hydroxyl ions produced on the cathode to the anode while being electrically insulating. Water is created on the anode. The anode reaction combines hydrogen fuel with the hydroxyl ions to produce water. This is known as the Hydrogen Oxidation Reaction (HOR). The cathode reduces oxygen in the presence of water to form hydroxyl ions. This is known as the Oxygen Reduction Reaction (ORR). The electrochemical reactions in an AAEM where hydrogen is the fuel are given below:

Anode: 2H₂+4OH−=4H₂O+4e⁻ (Reaction: HOR)

Cathode: O₂+2H₂O+4e⁻=4OH⁻ (Reaction: ORR)

Overall: 2H₂+O₂+2H₂O=4H₂O

In the case of an acidic fuel cell, if methanol rather than hydrogen is supplied as the fuel, the anode reaction promotes the Methanol Oxidation Reaction (MOR) while the cathode again promotes the Oxygen Reduction Reaction (ORR). These cell reactions in an acidic environment are as follows:

Anode: CH₃OH+H₂O=CO₂+6H⁺+6e⁻ (Reaction: MOR)

Cathode: 3/2O₂+6H⁺+6e⁻=3H₂O (Reaction: ORR)

Overall: CH₃OH+3/2O₂=CO₂+2H₂O

If methanol is supplied as fuel in an alkaline fuel cell the reactions are as follows:

Anode: CH₃OH+6OH⁻=5H₂O+CO₂+6e⁻ (Reaction: MOR)

Cathode: 3/2O₂+3H₂O+6e⁻=6OH⁻ (Reaction: ORR)

Overall: CH₃OH+3/2O₂=CO₂+2H₂O

These types of polymer electrolyte fuel cells (using either hydrogen or methanol) are useful especially for applications in the fields of transport, auxiliary power units, and combined heat and power (“CHP”) systems. CHP systems utilise both the electricity generated by fuel cells and also the “waste” heat, and so are highly efficient. Liquid electrolyte systems are often employed for stationary applications with power demands approaching 1 MW with hydrogen, or reformed hydrogen, as the primary fuel.

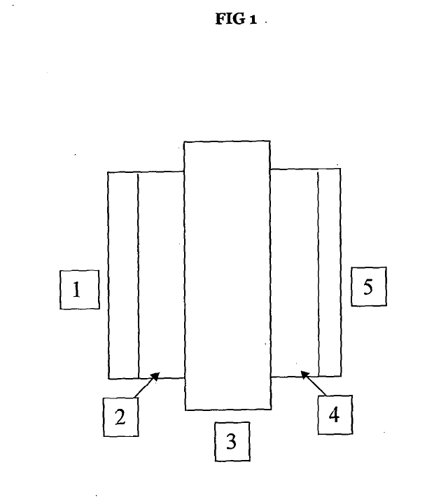

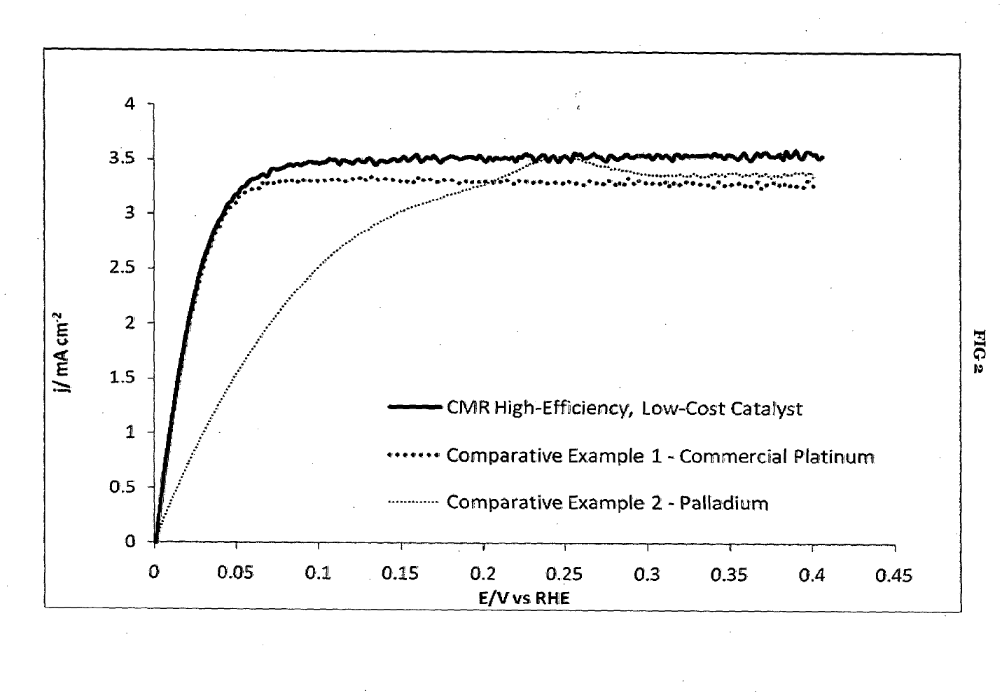

The principle component of any polymer electrolyte fuel cell is known in the art as a Membrane Electrode Assembly (MEA). Normally, the MEA is composed of five layers, although an MEA with sealing solutions integrated onto both electrodes is regarded as having seven layers. A general embodiment of the single cell employed in the polymer electrolyte fuel cell is shown in FIG. 1. Reference numeral 3 represents the solid polymer membrane acting as the electrolyte. The membrane must conduct the appropriate ions, be electrically insulating in order that the electrons can be driven around a circuit to do useful work, and be gas-impermeable. Immediately adjacent to the membrane interfaces are the catalyst layers. The anode catalyst layer (2) comprises a catalyst powder, either supported or unsupported, often but not always a binder, and a dispersed form of the same or similar ionic polymer contained in the membrane to allow ion transport throughout the catalyst layer. The anode catalyst is needed to accelerate the electro-oxidation of the fuel to a useful rate.

Adjacent to the anode catalyst layer is a diffusion medium (1). This layer may or may not be treated with a hydrophobic agent such as poly(tetrafluoroethylene) (PTFE). This is constructed from an electrically conducting, porous material. Components (1) and (2) are collectively termed the anode electrode in the art.

Adjacent to the opposite side of the membrane (3) is the cathode electrode. It also comprises a catalyst layer (4) containing a powdered catalyst, often a binder, and particulate form of the same or similar polymer contained in the membrane. The cathode catalyst is needed to accelerate the electro-reduction of oxygen. The cathode also comprises a layer of a diffusion medium (5) which is usually treated with a hydrophobic agent such as poly(tetrafluoroethylene) (PTFE).

The combination of layers 1, 2, 3, 4, and 5 are conventionally termed the membrane electrode assembly (MEA) within the art.

Inside the fuel cell, the MEA is placed between two flow-field plates. These are constructed of electrically conducting materials and usually contain a machined or embossed pattern which evenly distributes the fuel and air across the surface of the MEA electrodes. When the fuel and air are supplied to the MEA, they spontaneously react to produce an electrical current. The current then flows from the anode electrode to the anode flow-field plate. Here it is collected and directed by external electrical circuitry to power a device. The electrical circuit is completed by directing the electrical current from the device back into the cathode flow-field plate and into the cathode electrode. This process occurs continuously in the fuel cell until one or both of the reactant supplies are stopped. This may come about from the supply of fuel becoming exhausted, or the build up of reaction products. Therefore another function of the flow-field plates is to remove the products efficiently from the MEA.

Several MEAs are combined in series to form a fuel cell stack. This is usually done by using a flow-field plate which is machined or embossed with a flow pattern on both of its faces. One face supplies the anode electrode of one MEA with fuel; the other side supplies the cathode electrode of the adjacent MEA with air. This is conventionally termed a bi-polar flow-field plate. This is repeated down the length of the fuel cell stack. Stacking the MEAs in this way allows the individual voltages of the MEAs to sum in series. Then, the power output of the fuel cell stack is controlled by selecting the number of MEAs and bi-polar plates (defining voltage), and then defining the appropriate electrode area (defining current). Several other fuel cell stack architectures are possible, such as arranging the MEAs in a planar array and electrically connecting the electrodes externally in whatever configuration desired (e.g. connecting the cells in parallel, series, or even a hybrid combination of both).

The reactions which occur in industrial relevant acidic polymer electrolyte fuel cells are almost exclusively catalysed by platinum-based catalysts. Platinum is a relatively scarce metal and thus very expensive. Consequently, significant contribution to the high cost of acidic fuel cells comes from the high levels of platinum metal employed within the fuel cell stack. Automotive applications (generally, fuel cell stacks rated between 80-100 kW), require in excess of 30 grams of platinum, contributing a third of the total cost of the fuel cell system.

US2011/0081599 discloses the use of a three component electrode catalyst for fuel cells represented by the formula Pd₅IrMOₓ. It relates to the use of Pd and Ir for inducing an oxygen reduction reaction (cathode reaction) and describes a fuel cell containing a cathode electrocatalyst of the above formula and a PtRu/C anode electrocatalyst. The document does not describe the hydrogen oxidation reaction activity (i.e. HOR activity at the anode) of a Pd₅IrMOₓ electrocatalyst.

WO 2005/067082 discloses the use of a nanoporous/mesoporous palladium catalyst at the cathode with an ion-exchange electrolyte. The document concerns the production of a palladium catalyst with mesoporous or nanoporous morphologies using templating agents and aims to enhance its activity by increasing its surface area. The document does not however disclose the use of a palladium/iridium electrocatalyst at the anode of an acidic fuel cell.

Wang et al, Journal of Power Sources 175 (2008) 784-788 describes the use of a carbon-supported Pd—Ir catalyst as anodic catalyst in a direct formic acid fuel cell. The document does not however describe or suggest the use of such a catalyst in hydrogen, methanol or ethanol fuel cells.

WO 2008/012572A2 discloses the use of a lower cost single crystalline-phase palladium-ruthenium-platinum catalysts that are useful for the anode reaction in the acidic PEM-direct methanol fuel cell. These materials demonstrate similar activity to the state-of-the-art platinum-ruthenium alloys, but contain significantly lower levels of platinum. The long-term stability of these materials is not disclosed. This document does not describe a palladium/iridium catalyst.

CN101362094 describes a non-Pt catalyst for a fuel cell obtained by loading iridium and one or more transition metal elements onto a catalyst support. The use of an iridium/palladium catalyst at the anode of a fuel cell is not however disclosed. Furthermore, the inventors have identified advantages associated with the present invention compared to the catalysts described in CN101362094.

### DISCLOSURE OF THE INVENTION

The present invention is based on the finding that electrocatalysts combining palladium in combination with iridium are effective at the anode of an acidic fuel cell, i.e. are effective catalysts for the hydrogen oxidation reaction (HOR). In particular, it has been found that palladium-iridium catalysts are able to offer activities on a par with platinum when employed in an acidic fuel cell. In addition, palladium-iridium catalysts have been found to be surprisingly tolerant to carbon monoxide poisoning when employed at the anode of an acidic fuel cell. Moreover, palladium-iridium catalysts have been found to have advantageous catalytic activity to promote durability on a fuel cell anode. In particular, the catalysts have been found to be more active for water electrolysis than platinum, a feature that protects fuel cell anodes from detrimental corrosion during high voltage cycling events.

In a first aspect the invention provides a fuel cell comprising an anode which comprises an anode electrocatalyst comprising palladium and iridium; a cathode which comprises a cathode electrocatalyst; and an acidic electrolyte located between the anode and the cathode; wherein the fuel cell is a hydrogen, methanol, or ethanol fuel cell.

The iridium may be present as an alloy with the palladium, or may be present in non-alloy form.

The acidic electrolyte may be any conventional acidic electrolyte. For example, the acidic electrolyte may be a polymeric electrolyte or a liquid electrolyte (a cation conducting liquid) such as phosphoric acid. More specifically, the acidic electrolyte may be a proton exchange membrane, a free-flowing liquid electrolyte or a liquid electrolyte contained in a matrix. Suitable electrolytes for use in the invention are further described below.

In one preferred embodiment, a proton exchange membrane (PEM) is employed in the present invention as the acidic electrolyte. PEM's are very highly acidic materials which do not conduct electrons but are good conductors of protons. Such fuel cells rely on the ready availability of protons generated at the anode, which pass through the PEM, to react with electrons at the cathode. Accordingly, these fuel cells best operate at highly acidic pH, meaning that there is a plentiful supply of protons or hydrogen ions.

A proton exchange polymer is a polymer which readily transports protons along the polymer, but which is relatively resistant to the passage of anions and electrons. Typically, a proton exchange polymer permits the passage of protons at least 10 times more readily than it permits the passage of similarly sized anions. Preferably a proton exchange polymer will permit the passage of protons at least 50, or more preferably at least 100 times, more readily than the passage of similarly sized anions.

The relative ease with which anions and protons are transmitted by a polymer can be tested in a straightforward manner by, e.g. impedance spectroscopy as a function of temperature, using hot-pressed carbon paper/polymer/carbon paper samples completely immersed in deionized water. Preferred protocols are disclosed in Silva et al., J Power Sources 134, (2004) 18; and Silva et al., Electrochem Acta 49, (2004) 3211.

The proton exchange membrane (PEM) is a mature technology including now several different proton exchange chemistries. The most mature and prevalent technology is Nafion® from DuPont—polysulphonic tetrafluoroethylene. Nafion® is composed of a tetrafluoroethylene backbone with side chains terminated with a sulphonic acid group. The sulphonic acid group is the active group of the ionomer, providing the mechanism for the conduction of protons to the cathode.

Polybenzimidazole (PBI) can be used at higher temperatures and lower humidity levels than Nafion®, e.g. numerous examples of the PBI class of proton exchange membranes are described in Li et al, Fuel Cells, Vol 4, Issue 3, pp 147-159, August 2004.

Other proton/cation conducting membranes exist. For example, proton conducting membranes, especially with hydrocarbon backbone chemistry, are described in Rikukawa M and Sanui K, Prog. Polym. Sci. 25 (2000) 1463-1502. These membranes are typically thinner than their Nafion® counterparts, and they possess greater material strength.

Important characteristics for the proton conducting membranes are its conductivity and thickness. The preferred membrane for use in the various aspects of the invention consists of a film of thickness of at least 10 microns and preferably less than 200 microns. A preferred membrane thickness will typically be in the range of 15-100 microns and typical Nafion® membrane thickness for hydrogen fuel are on the order of 40-60 microns and on the order of 150 microns for methanol fuel. Often hydrocarbon based membranes will be thinner than their Nafion® counterparts on the order of 20-40 microns for either hydrogen or methanol fuel. The proton conductivity of the membrane is preferably greater than 100 mS/cm². State-of-the-art proton exchange membranes currently have conductivities in the range of 80-150 mS/cm².

The electrolyte separating the anode and the cathode in the fuel cell system need not be a proton conducting ionomer (as described above); an acidic liquid electrolyte may also be employed. An example of such a liquid electrolyte fuel cell with commercial applications is the Phosphoric Acid Fuel Cell (PAFC).

In many ways the PAFC is exactly like the proton exchange membrane fuel cells, except, instead of an ionomer membrane separating the anode and the cathode, a matrix doped or impregnated with phosphoric acid acts as the electrolyte conducting protons from the anode to the cathode. Often in PAFC applications the anode and the cathode are coated on carbon-fibre papers and employ platinum based catalysts. These electrodes might also contain proton exchange polymers within the layers, they may utilize the liquid electrolyte to promote a three phase boundary throughout the layers, or they may utilize a combination of both liquid electrolyte and ionomer to promote the three phase boundary throughout the electrode. The chemistry remains the same as in PEM fuel cells. The PAFC operates at elevated temperatures relative to the PEM with the typical range between 150-210° C. This temperature range is beneficial for combined heat and power efficiencies, for tolerance to fuel impurities, and for promoting platinum resistance to CO poisoning. Typically, PAFC have applications in stationary power generation operating from 250 kW-1 MW ranges. A well-cited book regarding PAFCs is Laramie and Dicks, “Fuel Cells Systems Explained” ISBN-10: 0471490261.

Furthermore, the liquid electrolyte need not be limited to phosphoric acid but can include any suitable liquid electrolyte enabling the half reactions at each electrodes to produce useful work.

The matrix containing the liquid electrolyte need not be limited to silicon carbide. Asbestos, sol-gels, polybenzimidazole (PBI) and other porous structures could be used. For example, PBI is described in Bjerrum N. et al, J. of Membrane Sci., Vol 226, (2003) pp 169-184.

In other embodiments according to the invention, the liquid electrolyte is not contained within in matrix but is flowing across the electrode surfaces in such a way that preserves the three phase boundary and enables the generation of electricity for useful work. This embodiment is analogous to the mobile liquid electrolyte systems found in many alkaline fuel cell systems.

It is well-documented that platinum catalysts are far superior to other materials and are preferred in acidic, proton exchange membrane fuel cells. For example, in Ralph and Hogarth, (“Catalysis for low temperature fuel cells, Part I: the Cathode Challenges” Plat Metals Rev, 2002, 46, (1), p 3), it is stated: “Pt-based electrocatalysts are required to provide stability in the corrosive environment of the PEMFC. These are also the most active electrocatalysts for oxygen reduction and among the most active for hydrogen oxidation.”

The present inventors have surprisingly found that, in the context of an acidic fuel cell, (especially with hydrogen as the primary fuel), the catalytic efficiency of a catalyst comprising both palladium and iridium is substantially similar to that of platinum for the anode electrode. These results have been verified with rotating disk electrode techniques familiar to those skilled in the art.

Those skilled in the art will appreciate that the catalyst will comprise functionally significant amounts of palladium and iridium, palladium and/or iridium alloys, palladium or iridium mixed amorphous state material and/or surface modified palladium/iridium, not merely tiny amounts present as impurities in other catalyst components. For present purposes, “functionally significant” amounts of palladium and iridium means sufficient to cause a detectable increase in catalyst activity as measured in terms of electrical current and electrode potential.

In one embodiment, the anode electrocatalyst may consist of palladium and iridium, i.e. contain only palladium and iridium. Also, the palladium and iridium may be present in substantially pure form (at least 99.1% pure), or may be present in a mixture with one or more additional elements.

The anode electrocatalyst may further comprise other catalyst components such as other metals. Suitable metals for inclusion in the anode electrocatalyst include ruthenium and cobalt.

The palladium in the electrocatalyst is believed to be intimately involved in the catalysis of the electrochemical reaction. However, other elements which may advantageously be included in the catalyst need not, necessarily, be actively involved in the catalysis. For example, they may exert a beneficial effect by improving or enhancing the stability of the palladium, by promoting useful side reactions for the long term durability of the system, or in some other way. Reference to these materials forming part of, or being comprised within, the electrocatalyst does not therefore necessarily imply that the materials in question have themselves catalytic activity for the electrochemical reactions catalysed by the electrocatalyst, though this may in fact be the case.

Those skilled in the art will appreciate that the palladium, iridium, and other catalyst components if present, will preferably be in a form which has a high surface area e.g. very finely divided or nanoparticulate or the like.

In one embodiment of the present invention, the anode electrocatalyst may have a composition of palladium-iridium in a 1:1 or 3:1 atomic ratio, or an atomic ratio of palladium-iridium between 1:1 and 3:1. Such ratios provide highly effective electrocatalysts.

As discussed above, platinum catalysts are the catalysts of choice exhibiting far superior properties when compared to other materials, but platinum is expensive. The surprising discovery of the present invention however allows the use of anode electrocatalysts containing low levels of platinum, and even allows the use of electrocatalysts containing no platinum. Platinum may be present in the anode electrocatalysts employed in the invention, although it will normally be preferred that platinum, if present, exists only in trace amounts (below 0.05 At %, preferably below 0.1 At %). More preferably, the anode electrocatalyst employed in the present invention contains no platinum. That is to say, the anode electrocatalyst employed in the present invention comprises palladium and iridium in the absence of platinum.

The fuel cell of the invention contains an anode which comprises palladium and iridium as described herein in the context of the present invention. The cathode may comprise the same electrocatalyst as the anode or a different electrocatalyst as the anode. Examples of suitable cathode electrocatalysts include platinum, alloys of platinum, platinum with additions of other elements, ruthenium, ruthenium/selenium, or perovskite and spinel catalyst structures.

In a preferred embodiment of the invention, the cathode electrocatalyst does not comprise a combination of palladium and iridium.

An example of such an embodiment has an anode electrode comprising or associated with a catalyst of palladium-iridium (and/or palladium-iridium with optional tertiary or further elemental additions) for a hydrogen oxidation reaction, with a different catalyst substance on or associated with the cathode for the oxygen reduction reaction, such as platinum or any platinum based combination, unalloyed palladium, or a useful perovskite structure. Preferably, the cathode electrocatalyst contains platinum.

The fuel cell of the present invention may be a hydrogen, methanol or ethanol fuel cell, preferably a hydrogen or methanol fuel cell, more preferably a hydrogen fuel cell.

The anode electrocatalyst may further comprise an electrocatalyst (acidic) electrolyte. This is an electrolyte dispersed within the catalyst layer. Examples of such electrolytes include a cation/proton exchange polymer (ionomer) electrolyte or a liquid acidic electrolyte contained in any suitable matrix or flowing through the electrodes. Preferably, the polymeric or liquid systems may be engineered in any configuration so long as the functional relationship between the electrocatalyst electrolyte and the catalyst maintains a three phase boundary necessary to produce useful electrical work.

The palladium/iridium in the catalyst is typically functionally associated with the electrocatalyst electrolyte. In the present context “functionally associated” refers to the ability to form what is known in the art as a “three phase boundary”. This is the coordination of the electrocatalyst electrolyte and the catalyst surface in any way which permits the mass transport of fuel (either liquid, gaseous, or both) to the catalyst surface while allowing the mass transport of reaction products away from the catalyst surface all while maintaining the appropriate ionic conductivity between the electrodes and the required electric conductivity to produce useful work. The electrocatalyst electrolyte will provide a conduction pathway for the ions away from the catalyst surface generating the ions, and ultimately to the catalyst surface utilizing the generated ions in the corresponding half-cell reaction. Therefore, the electrocatalyst electrolyte within the catalyst layer will be connected ionically to the acidic electrolyte employed in the fuel cell of the present invention, e.g. a proton exchange membrane, a flowing liquid acidic electrolyte, or a liquid acidic electrolyte contained within a suitable matrix. Clearly, the electrocatalyst electrolytes dispersed in the catalyst layer must form a pathway from the catalyst surface to the acidic electrolyte employed in the fuel cell of the present invention to the catalyst surface on the opposite electrode. This pathway need not be (and usually is not) linear. The ionic conduction pathways can be formed by liquid electrolytes, or a combination of ionomers and liquid electrolytes as well. When the ionomers and/or liquid electrolytes are functionally associated with the catalysts electricity can be generated from a fuel cell when fuel is supplied to the anode and oxidant to the cathode.

Conveniently, but not necessarily, the electrocatalyst may comprise the same electrocatalyst electrolyte as the acidic electrolyte employed in the fuel cell of the present invention.

The electrocatalyst employed in the present invention may be cured at any temperature however in a preferred embodiment the electrocatalyst is cured at a temperature of from about 130° C. to about 180° C., preferably about 150° C.

In one embodiment, the electrodes employed in the invention are diffusion electrodes, comprising an electrically conducting support, a diffusion material deposited on the support, and an electrocatalyst on the diffusion material. At the anode, the electrocatalyst is as defined above. The diffusion material will typically comprise an electrocatalyst electrolyte as described above such as a polymer, preferably a proton exchange polymer or a liquid electrolyte in a functional relationship with the catalyst where it also maintains the three phase boundary. Conveniently, but not necessarily, the diffusion material may comprise the same proton exchange polymer as that present in the electrocatalyst.

The electrodes used in the invention may also comprise an electrically conducting support. The construction of the anodes and cathodes will conveniently be generally very similar, but they may be different. Typically both the anode and cathode may be of essentially conventional construction and may comprise a conducting support including, but not limited to, one of the following: metallised fabrics or metallised polymer fibres, carbon cloth, carbon paper, and carbon felt. The conducting support may be in the form of a sintered powder, foam, powder compacts, mesh (e.g. titanium or stainless steel), woven or non-woven materials, perforated sheets, assemblies of tubes or the like, on which may be deposited, or otherwise associated therewith, electrocatalysts. At the anode, the conducting support may be in the form of a sintered powder, foam, powder compacts, mesh, woven or non-woven materials, perforated sheets, assemblies of tubes or the like, on which may be deposited, or otherwise associated therewith, electrocatalysts comprising palladium and iridium as described herein in the context of the present invention.

The precise preferred composition of the fuel cell of the invention will depend on a number of factors including, for example, power requirements, whether the fuel is hydrogen, hydrogen with other gaseous constituents, or methanol fuel, humidification factors, systems requirements, and the like. The preferred oxidant may typically comprise oxygen, air, or other oxygen-containing gas, but could also comprise liquid redox agents. The preferred fuel will comprise hydrogen, which may be in concentrated, substantially pure form, may be diluted hydrogen (for instance, hydrogen generated by ammonia crackers will have a significant fraction of nitrogen), or may be reformed natural gas which will contain fractional amounts of carbonaceous gases like carbon dioxide and carbon monoxide.

The fuel cell of the invention will be understood generally to further comprise the additional components of an otherwise conventional fuel cell, such as a fuel supply means, an air or oxygen supply means, electrical outlets, flow field plates or the like, a fuel or air/oxygen pump, and so on. Methods of constructing and operating fuel cells are well known to those skilled in the art. The preferred fuel for the fuel cell of the invention is hydrogen.

In a second aspect the invention provides a fuel cell stack, comprising a plurality of fuel cells in accordance with the first aspect of the invention. Methods of forming stacks of fuel cells are well known within the art. In the fuel cell stack of the invention, the cells may be electrically connected in series, or in parallel, or in a combination of both series and parallel connections and the plurality of fuel cells can be housed in any suitable stack architecture where useful electrical energy can be produced.

In a third aspect, the invention provides a method of making a fuel cell in accordance with the invention, the method comprising the step of assembling, in functional relationship, an anode, a cathode, and an electrolyte, wherein the anode and cathode each comprise a respective electrocatalyst, of which the anode electrocatalyst comprises palladium and iridium as described herein. Conveniently the method will additionally comprise positioning an acidic electrolyte between the anode and the cathode. For example, the method could involve positioning a proton exchange membrane as an electrolyte between the cathode and anode or an acidic liquid electrolyte either flowing between the anode and cathode or suitably contained within a matrix located between the anode and the cathode.

In an fourth aspect, the invention provides a method of generating electricity, the method comprising the step of supplying a fuel and an oxidant to a fuel cell in accordance with the second aspect, or a fuel cell stack in accordance with the third aspect, so as to cause the oxidation of the fuel and generate free electrons at the anode.

Typically the catalyst of the invention is formed by depositing the active catalytic particles onto a solid support to produce a high surface area. The solid support is preferably particulate in nature but may consist of woven fibres, non-woven fibres, nano-fibres, nano-tubes or the like. Preferably the support is a finely divided carbon black with exemplary examples being Denka Black, Vulcan XC-72R, and Ketjen Black® EC-300JD. Examples of other supports include graphite, acetylene blacks, furnace blacks, conducting metal oxides such as Ti₄O₇ (Ebonex®), mixed metal oxides, silicon carbide and tungsten carbide (WC, W₂C). Suitable polymer-based supports include polyaniline, polypyrrole and polythiophene. These are given as examples, but the nature of the support should not limit the claims of the invention.

If the electrocatalyst is supported on a high surface area support material, the loading of catalyst is preferably greater than 10 percent by weight (based upon the weight of the support material), and most preferably greater than 29 percent by weight. The electrocatalyst may also be used without support material in the form of a self-supported metal black.

Electrocatalyst layers and diffusion media may be brought together with an ionic polymer membrane using a lamination procedure utilising both heat and pressure to bond the electrodes to the membrane. A typical lamination procedure, not limiting to the invention, with a proton exchange membrane and associated electrodes is 450-550 psi (preferably 460 psi) at 130-180° C. (preferably 175° C.) for one to five minutes (preferably three minutes). A preferred procedure is 460 psi at 175° C. for three minutes.

The electrocatalyst employed in the present invention may be prepared using a method comprising the step of:
contacting palladium and iridium supported on an electrically conducting support with either: (i) a proton exchange polymer, or (ii) a mixture of proton exchange monomers and causing polymerisation thereof in situ; so as to form an intimate catalytically active mixture of the palladium and iridium on the electrically conducting support with the proton exchange polymer, or (iii) contacting the catalyst with a liquid electrolyte in such a way that the three phase boundary between the catalyst and the liquid electrolyte is maintained, or (iv) a combination of proton exchange ionomers and liquid electrolytes also maintained in such a way as to preserve the three phase boundary.

In a preferred embodiment, the method includes the initial step of forming an aqueous solution (conveniently at acidic pH) of a palladium salt and/or an iridium salt, and causing the precipitation of the palladium and/or iridium as palladium and/or iridium oxides respectively, in the presence of the electrically conducting support. This can conveniently be effected by adjusting the pH of the solution. Similarly, other metal salts present in the solution, if desired, can be precipitated as their metal oxides.

The palladium oxide and/or iridium oxide, may readily be reduced to palladium (or iridium, as appropriate) by use of a suitable chemical reducing agent. After this, the preparation may advantageously filtered, washed and dried. At this stage, the palladium and/or iridium will be supported on the electrically conducting substrate.

Suitable palladium and iridium salts include palladium nitrate, palladium chloride, and iridium chloride. Suitable reducing agents include, but are not limited to, sodium hypophosphite (NaH₂PO₂) and sodium borohydride (NaBH₄). A suitable reducing atmosphere is 5%-20% hydrogen in nitrogen or argon. Example firing conditions are 150° C. for one hour. This firing condition is advantageous to the present invention as it promotes the removal of hydroxides/oxides from the surface of the catalyst without promoting the sintering and loss of surface area of the catalyst.

The catalyst will typically be formed by depositing a porous layer of material on the anode. Methods of forming and depositing catalysts are in general well-known to those skilled in the art and do not require detailed elaboration. The exact qualities an anode layer requires—such as metal loading, GDL thickness, support type, etc are dependent upon several factors such as fuel, system operating conditions, etc with general rules of thumb for fabrication well-known throughout the art. Examples of generally suitable methods are disclosed in U.S. Pat. No. 5,865,968, EP0942482, WO2003103077, U.S. Pat. No. 4,150,076, U.S. Pat. No. 6,864,204, WO2001094668.

A general summation of these techniques follows: a mixture of one or more active catalytic materials and a particulate support is formed in the presence of a suitable solvent, and the mixture dried to cause deposition of the active catalytic materials onto the particulate support. In the present invention, it is preferred that the precursor mixture comprises a suspension of the material used to form the proton exchange membrane, or a material very similar thereto in chemical properties. An example of a proton exchange polymer dispersion is disclosed in EP-A-0577291.

Other substances may also be present in the electrocatalyst of the invention, including other metals. The catalyst may comprise two metals, three metals or even four or more different metals, in any desired or convenient ratio.

Suitable membrane exchange assemblies in accordance with the present invention and/or for use in the present invention may be prepared as follows:

In one embodiment, the fabrication of a five-layer proton exchange membrane electrode assembly consists of three general steps:
1. Preparation of a two layer anode electrode:
   a. Electrically conducting substrate with diffusion media
   b. Electrocatalyst layer
2. Preparation of a two layer cathode electrode:
   a. Electrically conducting substrate with diffusion media
   b. Electrocatalyst layer
3. Lamination of the anode and cathode electrodes onto a proton exchange membrane.

In certain cases, the electrodes need not be laminated to the proton exchange membrane but can simply be compressed against it. As discussed above, the fuel cell of the present invention may alternatively employ a liquid electrolyte. In most liquid electrolyte applications, the electrodes are simply brought into contact with the liquid electrolyte or the matrix containing the liquid electrolyte.

### Preparation of a Fuel Cell Electrode of Two Layers

In a five layer proton exchange polymer MEA, the assembly generally comprises (1) an electrically conducting substrate coated with diffusion media, (2) an anode electrocatalyst layer, (3) a proton exchange membrane, (4) a cathode electrocatalyst layer, and (5) an electrically conducting substrate coated with diffusion media.

The electrically conducting substrate may comprise, but is not limited to, one of the following: metallised fabric, metallised polymer fibres, foam, mesh, carbon cloth, carbon fibre paper, and carbon felt. A preferred example of an electrically conducting anode substrate is carbon fibre paper (TGP-H-030, -060, -090 from Toray® Corporation).

Diffusion materials are generally coated on the electrically conducting substrate. The coating processes can be any suitable process for those skilled in the art: screen printing, ink-jetting, doctor blade, k-bar rolling, spraying, and the like.

The diffusion material itself must also be electrically conducting. Typical examples of diffusion media include finely divided carbon blacks, with preferred examples being Denka Black, Vulcan XC-72R, and Ketjen Black EC-300JD, bound into an ink with the ion exchange polymer or, alternatively, with hydrophobic polymers such as PTFE. In the case of PTFE bound diffusion media, the substrate and the diffusion layer must be heat treated between 350-400° C. to allow the PTFE to flow. Examples of other potential diffusion materials include graphite, acetylene blacks, furnace blacks, conducting metal oxides such as Ti₄O₇ (Ebonex®), mixed metal oxides, silicon carbide and tungsten carbide (WC, W₂C). Suitable polymer-based supports include polyaniline, polypyrrole and polythiophene. The ratio of binder to diffusion media is typically within the range of 30-70% although operating conditions may require adjustments throughout and beyond this range. Examples within the art include U.S. Pat. No. 5,865,968 and WO 2003/103077. After the deposition and final processing of the diffusion media has been accomplished the combination of diffusion media and electrically conducting substrate is known in the art as a Gas Diffusion Substrate (GDS).

The electrocatalyst layer, in a five layer MEA, is usually deposited onto the GDS. This layer will, at a minimum, contain the electrocatalyst material and the proton exchange polymer. The polymer must be in contact with the electrocatalyst in a functional manner. Within the art, the electrocatalyst and electrolyte interface is known within the art as a “three-phase boundary” where all three phases of matter can be present and where the fuel and oxidant can readily access the catalyst surface while the formation products can easily escape from the catalyst surface. The catalyst layer may have other materials present to provide additional functionality or benefits. Such examples include PTFE to promote the removal of water products, (PTFE being highly hydrophobic).

The electrocatalyst layer can be deposited onto the diffusion media and electrically conducting substrate with any number of methods well-known within the art: screen-printing, spraying, or rolling. Such techniques are described in EP577291.

The following is an example of making a complete MEA for use in the present invention. It is intended to illustrate and not limit the invention.

### Anode Electrode with Proton Exchange Polymer

The fabrication of anode electrodes with proton exchange polymers is well known throughout the art. These electrodes typically consist of two layers each: 1. A microporous Gas Diffusion Layer (GDL, also known as a Gas Diffusion Electrode when printed on a substrate), and 2. The electrocatalyst layer.

The GDL is typically composed of an electrically conducting substrate like a carbon cloth or carbon fibre paper, Toray® brand being an excellent commercial example of the latter. Upon this substrate a carbon ink layer is printed and dried. Any number of carbons can be employed, typical examples being Vulcan XC-72R, Denka compressed carbons, or Ketjen Black® EC-300JD. In PEM MEAs, the typical binder for this ink layer is the proton conducting polymer itself, again Nafion® being the most prevalent example. Carbon loadings are typically being between 0.2-0.7 mg/cm², but can vary greatly by application, for instance, higher loadings in low relative humidity operating environments. In some instances hydrophobic agents like PTFE can be employed as the binder or in combination with the proton exchange polymer. Several different GDL technologies are available commercially, examples being ELAT™ GDL from E-Tek, SIGRACET® GDL from SGL-Group.

Once the gas diffusion layer is dry, the electrocatalyst layer is then deposited upon the Gas Diffusion Electrode by any number of techniques (screen-printing, ink-jet printing, doctor blade, etc). The electrocatalyst ink for the deposition generally contains the electrocatalyst, in this case Pd—Ir, and a proton conducting matrix, generally a proton exchange polymer dispersion. Non-ionic conducting polymers can be used as a binder where a liquid acidic electrolyte medium acts as the proton/cation conducting matrix although the proton exchange polymers can be employed in this case as well. The electrocatalyst may be unsupported, known as a catalyst black in the art. A preferred embodiment is the electrocatalyst deposited on a high surface area carbon support. The electrocatalyst layer is applied to a range of catalyst loadings, depending on application. For hydrogen fuel, the anode loading is typically between 0.05-0.5 mg electrocatalyst/cm² with preferred embodiments at the lower end of the scale. For methanol fuel, the loadings are typically higher being anywhere between 0.25-1.0 mg electrocatalyst/cm², again with preferred embodiments at the lower end of the scale.

The cathode electrode will possess a suitable oxygen reduction reaction catalyst (ORR) generally also containing a proton/cation conducting polymer matrix. Although any suitable ORR electrocatalyst is acceptable for the cathode, the most efficient ORR electrocatalysts in an acidic environment are platinum and platinum alloys. The fabrication of the cathode electrode is very similar to the fabrication of the anode electrode, and numerous examples exist within the art. The primary differences are 1. the cathode GDL, and even the electrocatalyst layer itself, is almost always treated with a hydrophobic material such as PTFE to facilitate the removal of water produced at the catalyst surface in an effort to preserve the three phase boundary within the electrocatalyst layer, preventing what is known in the art as “flooding” of the cathode, and 2. The electrocatalyst loadings on the cathode are generally higher than on the anode because of the lower kinetics of the oxygen reduction reaction relative to the hydrogen oxidation reaction.

### Lamination of the Anode and Cathode Electrode to a Proton Exchange Membrane

Both the anode electrode and the cathode electrode are typically aligned and laminated together on opposite sides of a proton exchange membrane although the electrodes can also be brought into functional contact with an acidic liquid medium as well. The process improves the contact between the membrane and the electrode, usually improving catalyst utilisation within the electrode layer. Most commonly the electrodes are placed in a hot press utilising the heat and pressure to ensure better contact between the five layer assembly. However, in certain embodiments, the electrodes can simply be compressed against the membrane within the fuel cell and not require the lamination step at all. An acidic liquid matrix would also not require a lamination step.

Lamination protocols vary, mostly influenced by the membrane chemistry and its thickness. A suitable protocol for a wide variety of PFSA membranes is 175° C. at 460 psi (3.17 MPa) for three minutes. The aryl- and alkyl-sulfonated aromatic polymer electrolyte membranes (PBI class) degrade at higher temperatures relative to the PFSA membranes and different lamination techniques may be appropriate. The specifics of any (or even no) lamination technique should not limit the scope of the invention.

This laminated unit is the Membrane Electrode Assembly. This assembly can be placed between bipolar flow field plates with several flow field plate and MEA assemblies linked electrically either in series or in parallel or in combinations of both forming a proton exchange membrane fuel cell. Other fuel cell stack assemblies are possible, such PCB boards with electrically conducting passivation layers on the copper machined in such a way as to act as current collectors and gas manifolds. Three layer assemblies are also possible and known as known as Catalysed Coated Membranes (CCM) within the art. These comprise (1) an anode electrocatalyst layer, (2) a proton exchange membrane, and (3) a cathode catalyst layer. These are prepared by a transfer process where the electrocatalyst layers are printed onto a decal (such as PTFE and/or Kapton) and transfer laminated onto the proton exchange membrane.

Numerous examples of platinum based membrane electrode assemblies exist in the literature and numerous commercially available examples exist. An early patent detailing these techniques is EP 0577291(A1) [Hards and Ralph, 5 Jan. 1994, Johnson Matthey]; a publication detailing preparation of electrocatalyst layers and the required metrics for non-Pt catalysts to replace platinum is Gasteiger et al., Applied Electrocatalysis B: Environmental, 56 (2005), 9-35; an example of a gas diffusion electrode is U.S. Pat. No. 5,865,968 [Denton, Gascoyne, Potter, 2 Feb. 1999, Johnson Matthey].

The invention will now be described by reference to examples, which are intended to be illustrative and not limiting to the invention.

Reference is also made to the accompanying drawings, in which:

FIG. 1 is a schematic representation of a typical membrane electrode assembly for use in a fuel cell.

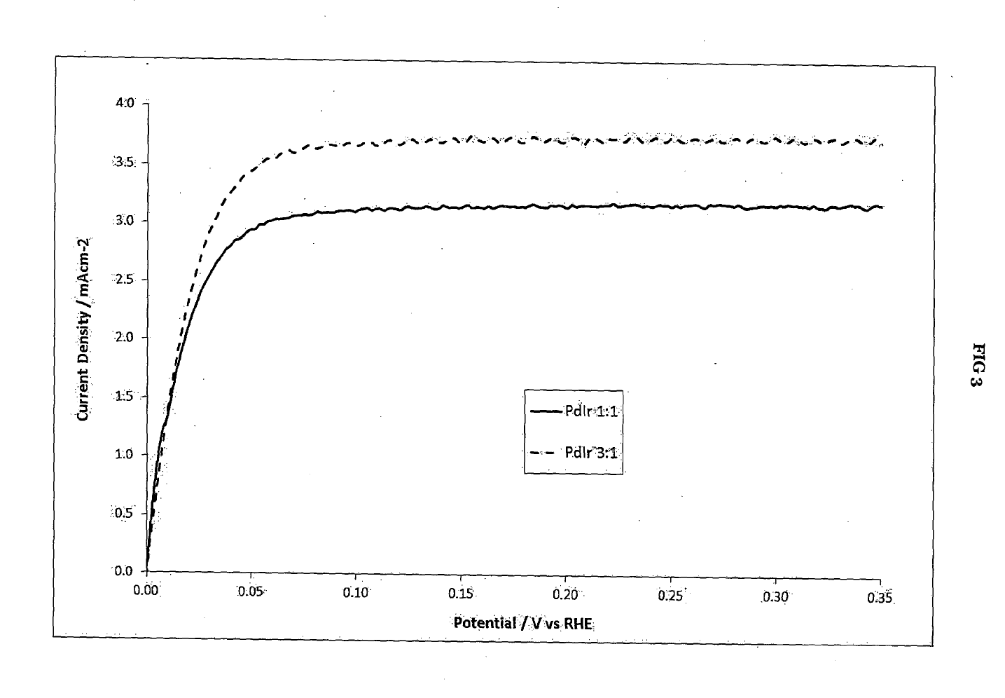

FIG. 2 is a graph showing the HOR activity on a rotating disk electrode for a catalyst in accordance with the present invention compared to other catalysts.

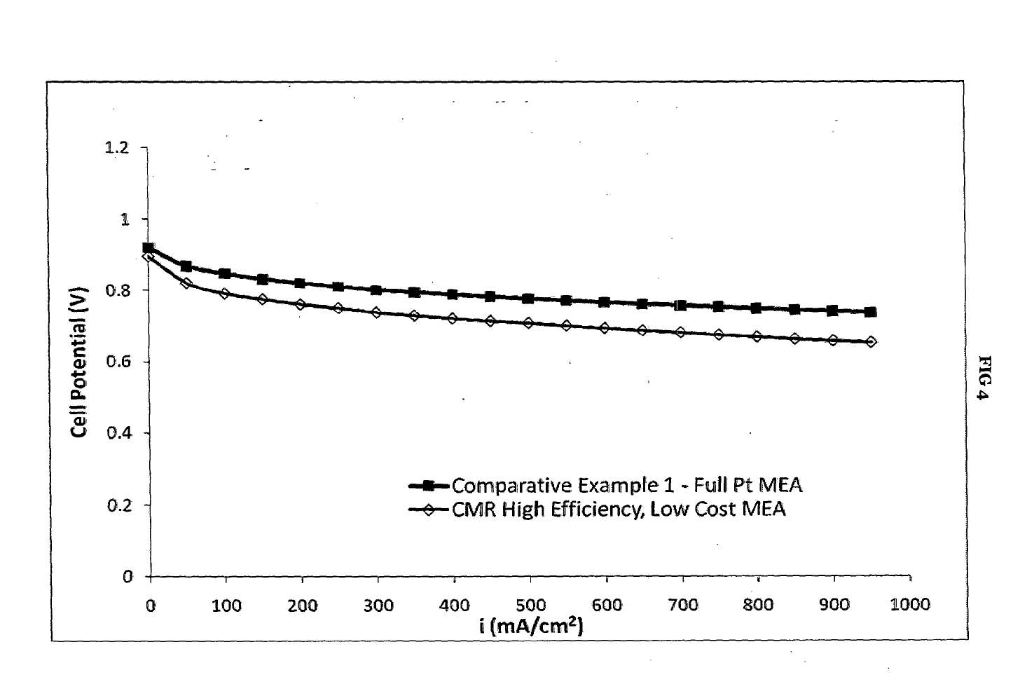

FIG. 3 is a graph showing the HOR activity on a rotating disk electrode for catalysts in accordance with the present invention having different Pd:Ir ratios.

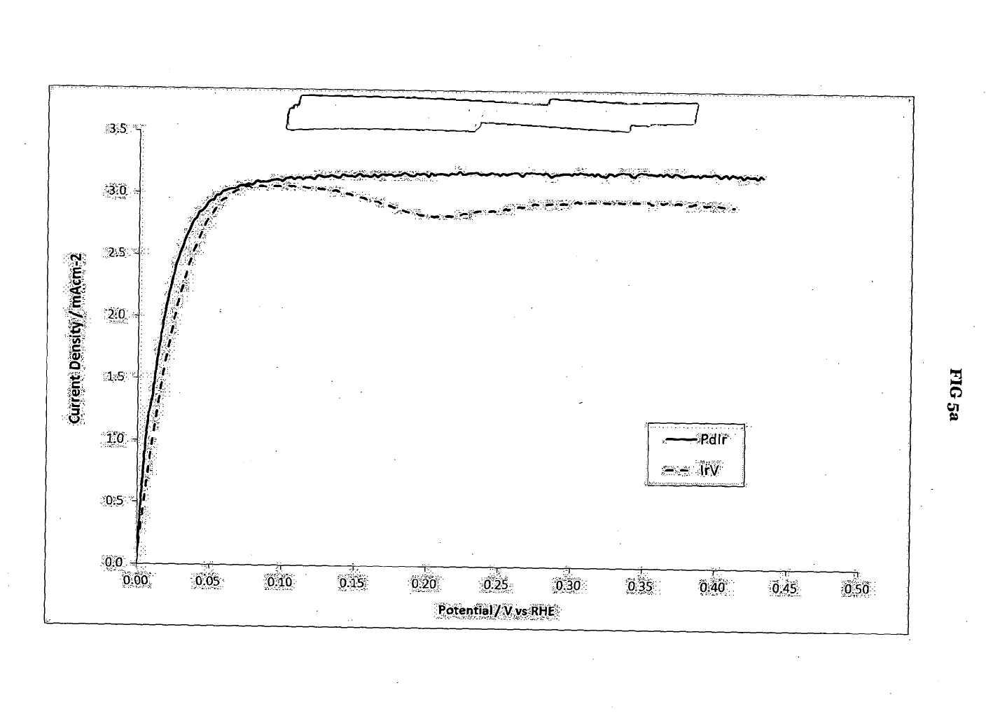

FIG. 4 is a graph showing the performance of an MEA using a proton exchange membrane with the catalysts in accordance with the invention and a comparative example using platinum catalysts not in accordance with the invention.

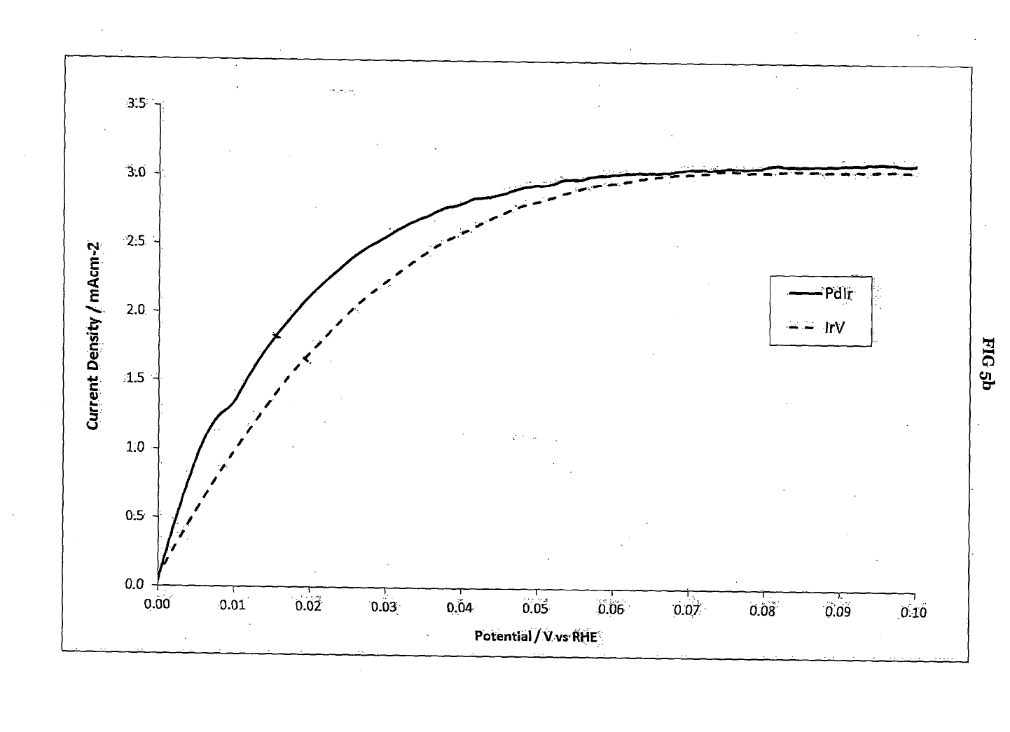

FIGS. 5a and 5b are graphs showing the HOR activity on a rotating disk electrode for a catalyst in accordance with the present invention compared to an iridium-vanadium catalyst.

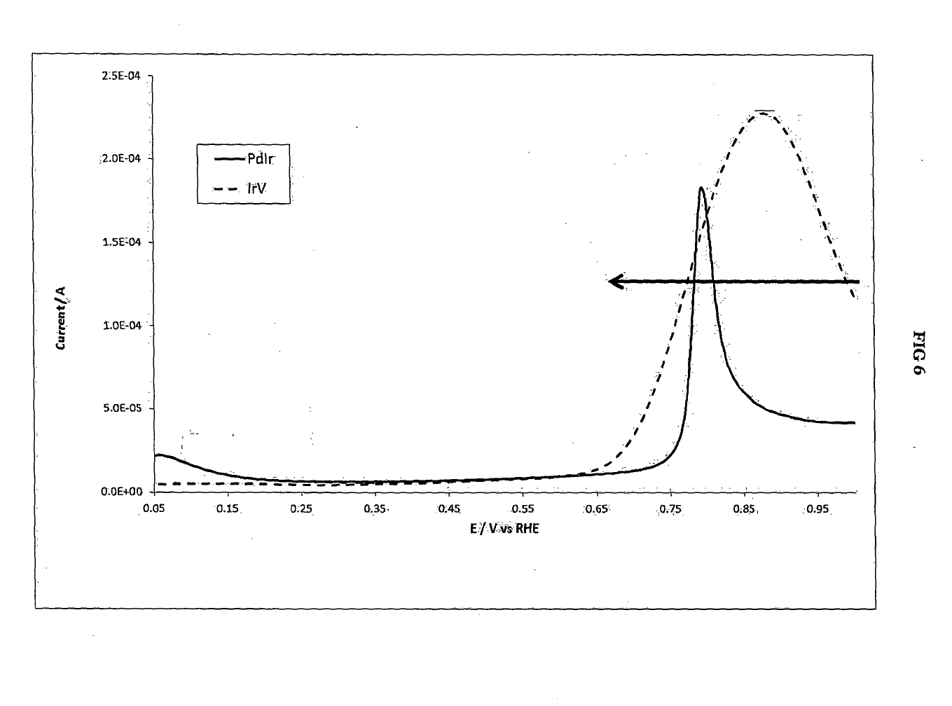

FIG. 6 is a graph showing the carbon monoxide tolerance observed in a palladium-iridium electrocatalyst in accordance with the present invention compared to an iridium-vanadium catalyst.

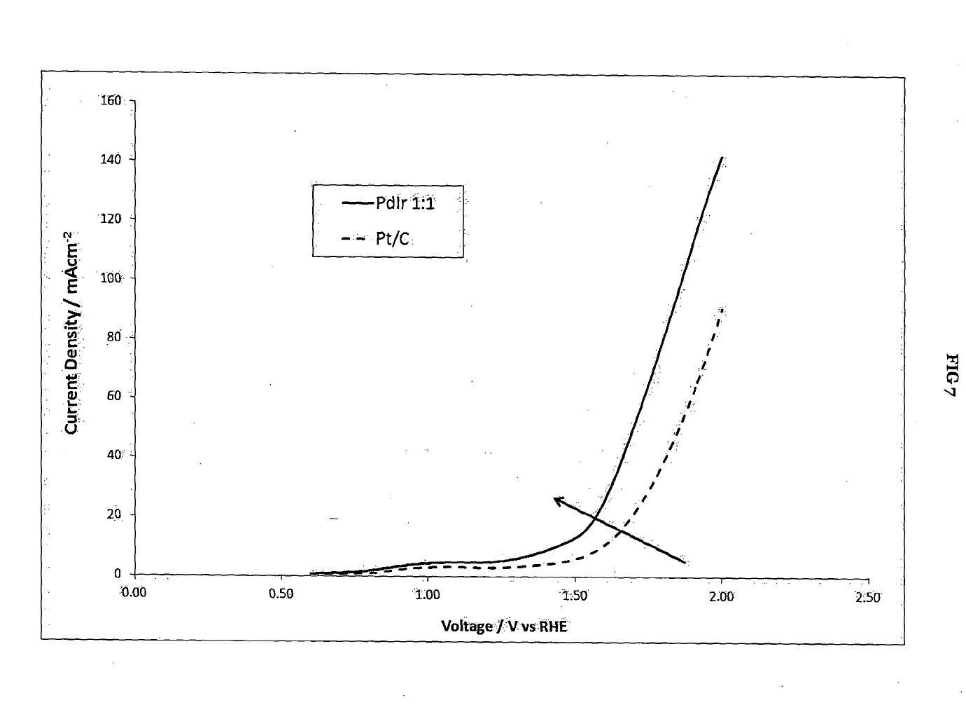

FIG. 7 is a graph showing the activity of a palladium-iridium catalyst in accordance with the present invention towards oxygen evolution compared to a platinum catalyst.

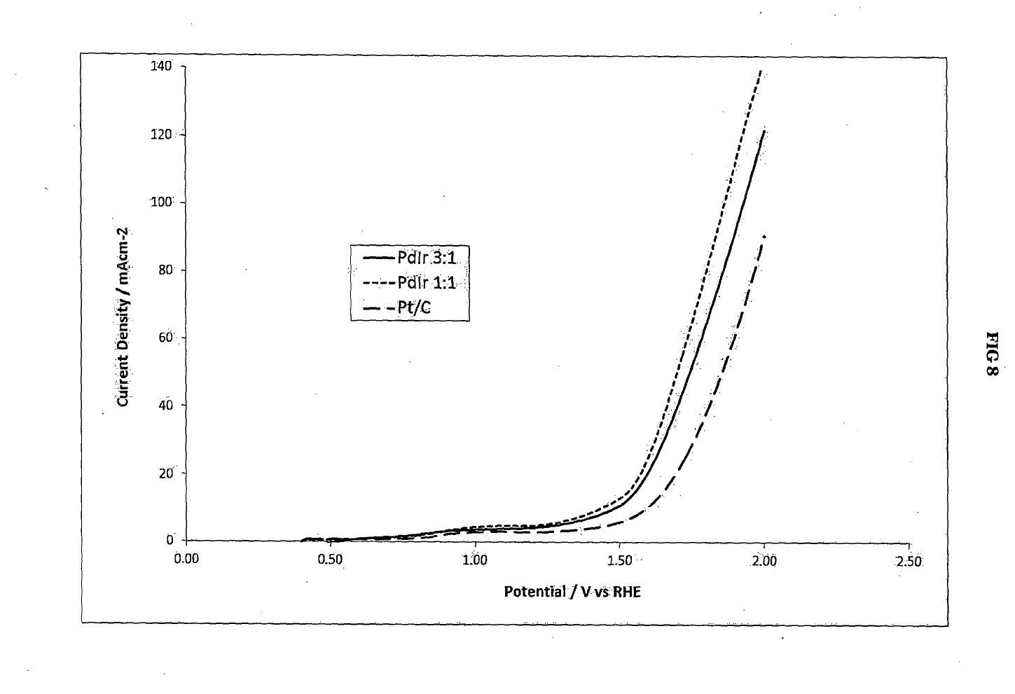

FIG. 8 is a graph showing the activity of palladium-iridium catalysts having different Pd:Ir ratios in accordance with the present invention towards oxygen evolution compared to a platinum catalyst.

For the avoidance of doubt it is hereby expressly stated that features of the invention described herein as “advantageous”, “convenient”, “preferable”, “desirable” or the like may be present in the invention in isolation, or in any combination with any one or more other features so described, unless the context dictates otherwise. In addition, all preferred features of each of the aspects of the invention apply to all the other aspects of the invention mutatis mutandis, unless the context dictates otherwise.

### EXAMPLES

### Example 1

### Palladium/Iridium Catalyst on Carbon [PdIr (1:1 at %)], 150° C.

Carbon black (Ketjen Black EC300JD, 0.8 g) was added to 1 litre of water and heated to 80° C. in round-bottom flask. The carbon was dispersed using an overhead stirrer and a paddle for 12 hours.

Into a second vessel, palladium nitrate (0.475 g, assay 42.0% Pd by weight) was carefully weighed and dissolved in 50 ml of deionised (DI) water. Into a third vessel iridium chloride (0.660 g, assay 54.4% Ir by weight) was carefully weighed and dissolved into 50 ml of DI water. The salts were then carefully pumped into the bottom of the vessel containing the stirring carbon slurry at 80° C.

Once the metal salts had been transferred to the larger vessel, the remaining contents of the dropping funnel were washed into the larger vessel. Then the pH of the stirring slurry was carefully increased to 7.0 by the addition of a saturated solution of sodium bicarbonate (NaHCO₃). The pH of the slurry was maintained at 7.0-7.5 for 1 hour by further controlled addition of sodium bicarbonate.

A sodium hypophosphite (NaH₂PO₂, 0.495 g diluted in 50 ml of DI water) solution was prepared. Two and half times the molar amount of palladium in the catalyst is a suitable amount of sodium hypophosphite to use. Half of this solution was pumped into the bottom of the reaction vessel containing the carbon-salt slurry. The slurry was maintained at 80° C. for an additional hour with continuous stirring.

After cooling the slurry down to room temperature, the filtrate was recovered and washed on a microporous filter until the filtrate conductivity was 2.42 mS. The catalyst was dried in an oven at 80° C. for 10 hours. The dried catalyst was then broken up in a pestle and mortar to give a fine powder, which was carefully placed into a ceramic boat to a maximum depth of 5 mm. The boat was placed in a tube-furnace and heated under a 20% H₂/80% N₂ atmosphere for 1 hour at 150° C. The yield for 1.4 g for a 40 metal wt % was 1.23 g.

X-ray diffraction profile analysis confirmed the presence of a single face centred cubic (fcc) lattice. The average Pd crystallite size was 5.4 nm. The preferred crystallite size range is greater than or equal to 3 nm and less than or equal to 10 nm and most preferably between 3 and 6 nm. This has been typical of all catalysts in the present examples annealed at 150° C.

### Example 2

### Palladium Iridium Catalyst on Carbon [PdIr (3:1 at %)], 150° C.

Carbon black (Ketjen Black EC300JD, 0.79 g) was added to 1 litre of water heated to 80° C. in round-bottom flask. The carbon was dispersed using an overhead stirrer and a paddle for 12 hours.

Into a second vessel, palladium nitrate (0.841 g, assay 42.0% Pd by weight) was carefully weighed and dissolved in 50 ml of DI water. Into a third vessel iridium chloride (0.383 g, assay 54.4% Ir by weight) was carefully weighed and dissolved into 50 ml of DI water. The salts were then carefully pumped into the bottom of the vessel containing the stirring carbon slurry at 80° C.

Once the metal salts had been transferred to the larger vessel, the remaining contents of the dropping funnel were washed into the larger vessel. Then the pH of the stirring slurry was carefully increased to 7.0 by the addition of a saturated solution of sodium bicarbonate (NaHCO₃). The pH of the slurry was maintained at 7.0-7.5 for 1 hour by further controlled addition of sodium bicarbonate.

A sodium hypophosphite (NaH₂PO₂, 0.870 g diluted in 50 ml of DI water) solution was prepared. Two and half times the molar amount of palladium in the catalyst is a suitable amount of sodium hypophosphite to use. Half of this solution was pumped into the bottom of the reaction vessel containing the carbon-salt slurry. The slurry was maintained at 80° C. for an additional hour with continuous stirring.

After cooling the slurry down to room temperature, the filtrate was recovered and washed on a microporous filter until the filtrate conductivity was 2.42 mS. The catalyst was dried in an oven at 80° C. for 10 hours. A portion of the dried catalyst was then broken up in a pestle and mortar to give a fine powder, which was carefully placed into a ceramic boat to a maximum depth of 5 mm. The boat was placed in a tube-furnace and heated under a 20% H₂/80% N₂ atmosphere for 1 hour at 150° C. The yield for 1.4 g for a 40 metal wt % was 1.20 g.

### Example 3

### Palladium/Iridium Catalyst on Carbon [PdIr (1:1 at %)], 600° C.

Carbon black (Ketjen Black® EC300JD, 0.81 g) was added to 1 litre of water heated to 80° C. in round-bottom flask. The carbon was dispersed using an overhead stirrer and a paddle for 12 hours.

Into a second vessel, palladium nitrate (0.480 g, assay 42.0% Pd by weight) was carefully weighed and dissolved in 50 ml of DI water. Into a third vessel iridium chloride (0.661 g, assay 54.4% Ir by weight) was carefully weighed and dissolved into 50 ml of DI water. The salts were then carefully pumped into the bottom of the vessel containing the stirring carbon slurry at 80° C.

Once the metal salts had been transferred to the larger vessel, the remaining contents of the dropping funnel were washed into the larger vessel. Then the pH of the stirring slurry was carefully increased to 7.0 by the addition of a saturated solution of sodium bicarbonate (NaHCO₃). The pH of the slurry was maintained at 7.0-7.5 for 1 hour by further controlled addition of sodium bicarbonate.

A sodium hypophosphite (NaH₂PO₂, 0.501 g diluted in 50 ml of DI water) solution was prepared. Two and half times the molar amount of palladium in the catalyst is a suitable amount of sodium hypophosphite to use. Half of this solution was pumped into the bottom of the reaction vessel containing the carbon-salt slurry. The slurry was maintained at 80° C. for an additional hour with continuous stirring.

After cooling the slurry down to room temperature, the filtrate was recovered and washed on a microporous filter until the filtrate conductivity was 2.42 mS. The catalyst was dried in an oven at 80° C. for 10 hours. A portion of the dried catalyst was then broken up in a pestle and mortar to give a fine powder, which was carefully placed into a ceramic boat to a maximum depth of 5 mm. The boat was placed in a tube-furnace and heated under a 20% H₂/80% N₂ atmosphere for 1 hour at 600° C. The yield for 1.4 g for a 40 metal wt % was 1.20 g.

### Example 4

### Palladium/Iridium Catalyst on Carbon [PdIr (3:1 at %)], 600° C.

Carbon black (Ketjen Black® EC300JD, 0.80 g) was added to 1 litre of water heated to 80° C. in round-bottom flask. The carbon was dispersed using an overhead stirrer and a paddle for 12 hours.

Into a second vessel, palladium nitrate (0.835 g, assay 42.0% Pd by weight) was carefully weighed and dissolved in 50 ml of DI water. Into a third vessel iridium chloride (0.385 g, assay 54.4% Ir by weight) was carefully weighed and dissolved into 50 ml of DI water. The salts were then carefully pumped into the bottom of the vessel containing the stirring carbon slurry at 80° C.

Once the metal salts had been transferred to the larger vessel, the remaining contents of the dropping funnel were washed into the larger vessel. Then the pH of the stirring slurry was carefully increased to 7.0 by the addition of a saturated solution of sodium bicarbonate (NaHCO₃). The pH of the slurry was maintained at 7.0-7.5 for 1 hour by further controlled addition of sodium bicarbonate.

A sodium hypophosphite (NaH₂PO₂, 0.869 g diluted in 50 ml of DI water) solution was prepared. Two and half times the molar amount of palladium in the catalyst is a suitable amount of sodium hypophosphite to use. Half of this solution was pumped into the bottom of the reaction vessel containing the carbon-salt slurry. The slurry was maintained at 80° C. for an additional hour with continuous stirring.

After cooling the slurry down to room temperature, the filtrate was recovered and washed on a microporous filter until the filtrate conductivity was 2.42 mS. The catalyst was dried in an oven at 80° C. for 10 hours. A portion of the dried catalyst was then broken up in a pestle and mortar to give a fine powder, which was carefully placed into a ceramic boat to a maximum depth of 5 mm. The boat was placed in a tube-furnace and heated under a 20% H₂/80% N₂ atmosphere for 1 hour at 600° C. The yield for 1.4 g for a 40 metal wt % was 1.19 g.

### Comparative Example 1

### Commercial Platinum Catalyst

A commercially available carbon-supported platinum electrodes with (40% by weight platinum) was obtained from Alfa Aesar®.

### Comparative Example 2

### Palladium Catalyst on Carbon Support

Carbon black (Ketjen Black® EC300JD, 10 g) was mixed with 5 litres of water in a glass lined reactor which employed a thermostatically controlled heated water jacket. The carbon was dispersed in the water with an overhead stirrer which employed a PTFE anchor paddle (200 rpm). The slurry was then heated to reflux and was then slowly cooled to 60° C. with constant stirring. The slurry was then stirred at 60° C. for a further 12 hours. 0.5 L of room temperature water is added to a second stirred vessel. To this was added palladium chloride crystals (11.19 g PdCl₂, 59.5% Pd by weight) with continuous stirring. Carefully, concentrated hydrochloric acid was added to acidify the solution and to dissolve the palladium chloride solid. When this was completely dissolved, the salt solution was then carefully added to the stirring carbon slurry at 60° C. over a period of 10 minutes. The pH of the carbon-salt slurry was then increased to 7 by the addition of a saturated solution of sodium bicarbonate (NaHCO₃ saturated at 20° C.) by the use of a dropping-funnel. The pH of the slurry was maintained at 7.0-7.5 for 1 hour by further controlled addition of sodium bicarbonate.

A third solution was then prepared which contained sodium hypophosphite (NaH₂PO₂, 6.6 g) dissolved in 100 ml of water. The sodium hyposhosphite reducing agent was then carefully pumped over a 5 minute period to the bottom of the reaction vessel by a tube where it was rapidly mixed with the slurry. The mixture was then heated for a further hour at 60° C.

The slurry was then cooled to room temperature. The catalyst was then recovered by filtration and washed on a microporous filter. The catalyst was dried in an oven at 80° C. in air for 10 hours. The weight loading of palladium on carbon was about 40%.

The dried catalyst was then carefully broken up in a pestle and mortar to give a fine powder. This was then carefully placed into ceramic boats to a maximum depth of 5 mm. These were then placed in a tube-furnace and heated under a 20% H₂/80% N₂ atmosphere for 2 hours at 150° C.

A summary of all the foregoing examples is given in Table 1.

TABLE 1

| | Weight % loading | | | Atomic % | | | Annealing |
|---|---|---|---|---|---|---|---|
| Ex No. | Pd | Ir | Pt | Pd | Ir | Pt | Temp |
| Example 1 | 14.5 | 25.8 | — | 50.5 | 49.5 | — | 150 |
| Example 2 | 26.1 | 15.4 | — | 75.4 | 24.6 | — | 150 |
| Example 3 | 14.7 | 26.2 | — | 50.3 | 49.7 | — | 600 |
| Example 4 | 25.8 | 15.4 | — | 75.2 | 24.8 | — | 600 |
| Comp Ex 1 | — | — | 40 | — | — | 100 | — |
| Comp Ex 2 | 40.0 | — | — | 100 | — | — | 150 |

### Comparative Testing: Rotating Disk Electrode (RDE) for Hydrogen Oxidation Reaction (HOR)

The palladium-iridium electrocatalysts of the present invention have been identified as exhibiting excellent properties compared to those known in the art. For example, the electrocatalysts of the present invention have been shown to be efficient catalysts of the hydrogen oxidation reaction at the anode of a fuel cell.

Comparing the efficacy of the catalyst of Example 1 was done with a Rotating Disk Electrode. Rotating Disk Electrode (RDE) experimental techniques will be familiar to those skilled in the art, e.g. an example is described in Gasteiger et al, Applied Catalyst B, 2005.

All HOR testing was done in a 0.1M perchloric acid as the liquid electrolyte. All samples were tested against a Standard Calomel Electrode as the reference electrode and then corrected to Real Hydrogen Electrode potentials; all samples were tested at room temperature, at 1600 rpm, and with a 2 mV/second voltage sweep rate. All catalyst inks for the electrodes were prepared using techniques outlined previously with loadings of 35 micrograms/cm² on rotating disk. The perchloric acid solution was bubbled with hydrogen for 30 minutes prior to each test.

A catalyst employed in the present invention (Example 1) was tested alongside a commercially available platinum catalyst (Comparative Example 1) and a catalyst containing only palladium (Comparative Example 2).

The results shown in FIG. 2 demonstrate that the electrocatalyst of Example 1 (labelled CMR High-Efficiency, Low-Cost Catalyst) exhibits intrinsic activity in acidic conditions comparable (in fact nearly equivalent) to that of Comparative Example 1 (commercially available platinum catalyst). Furthermore, the palladium-iridium catalyst of Example 1 is seen to exhibit far superior activity than a catalyst containing only palladium (Comparative Example 2).

A palladium-iridium (3:1) catalyst of the present invention (Example 2) was also tested. In FIG. 3, the hydrogen oxidation reaction kinetics are compared between the 3:1 ratio and the 1:1 ratio, and as can be seen, the two ratios exhibit similar activity for hydrogen oxidation.

### Catalyst Testing in an Acidic Fuel Cell Environment

Comparing the efficacy of the example catalyst was also done by laminating prepared electrodes onto a commercially available proton exchange membrane.

For comparative purposes, platinum electrodes were acquired from Alfa Aesar® (part number: 045372). These electrodes were used for both the anode (HOR) and the cathode (ORR), and laminated onto Nafion® 212 commercially available membrane at 460 psi, 175° C. for three minutes. This formed a bonded catalysed substrate MEA with a proton exchange membrane.

For testing the membrane electrode assembly of the present invention, platinum electrodes acquired from Alfa Aesar® (part number: 045372) were used for the cathode. An anode catalyst was prepared according to the method described in Example 1. This was coated onto a commercially available gas diffusion layer purchased from Johnson Matthey using a brush coat technique to a total metal loading of 0.45 mg PdIr/cm²—analogous to the calculated 0.45 mg Pt/cm² on the Alfa Aesar® electrode. The anode and the cathode were laminated onto Nafion® 212 commercially available membrane at 460 psi, 175° C. for three minutes. This formed a bonded catalyst substrate MEA with a proton exchange membrane with the present invention forming the electrocatalyst of the anode.

Both the platinum-based membrane electrode assembly and the inventive catalyst-based membrane electrode assembly were tested in the same cell hardware with hydrogen as the fuel and pure oxygen as the oxidant. The temperature of the cell was held at 80° C. and fuel and oxidant streams were humidified to dew points of 79.6° C. Both streams were at one atmosphere of pressure within the cell hardware.

FIG. 4 shows a comparison of the performance of the platinum-based MEA with the catalysts of the invention in an acidic fuel cell environment. The graph in FIG. 4 shows the polarisation curve (cell voltage, measured in volts, against current density measured in milliamps per cm²) for the conventional platinum catalyst-based MEA (square symbols) and for the palladium catalyst-based MEA of the invention (diamond symbols). As seen in FIG. 4, the cell polarization curve of the electrode assembly of the present invention is almost as good as the platinum based electrode assembly. Polarization such as this has not been observed before in a non-platinum catalyst. Thus, the data confirms that, surprisingly, the palladium/iridium catalysts work equally as well as a platinum catalyst.

### Comparative Example 3

An iridium-vanadium (IrV) catalyst as described in CN101362094 was prepared in accordance with the procedure outlined in Example 5 of CN101362094.

In summary, the major steps of this procedure include dissolving iridium chloride and ammonium metavanadate in ethylene glycol in the presence of a carbon support. The solution is then heated under a nitrogen atmosphere at 120° C. The ethylene glycol acts as the reducing agent at this temperature. The slurry is then filtered, the catalyst cake recovered and dried in the oven. Finally, the catalyst is heat treated in a 9:1 nitrogen-hydrogen atmosphere at 200° C. for two hours.

### Comparative Testing: Hydrogen Oxidation Reaction

An iridium-vanadium catalyst (Comparative Example 3) was tested alongside a catalyst of the present invention (Example 1) containing palladium and iridium (palladium-iridium). In particular, the Hydrogen Oxidation Reaction response of both the iridium-vanadium catalyst and the palladium-iridium catalyst were recorded.

HOR testing (linear voltage sweeps) was done in hydrogen saturated 0.1M perchloric acid as the liquid electrolyte with the disk rotating at 1600 rpm and a scan rate of 2 mV/sec using thin-film RDE techniques well-established within the art (Gasteiger et al, Applied Catalyst B, 2005).

The results are shown in FIG. 5a and FIG. 5b and demonstrate that the palladium-iridium catalyst of the present invention (Example 1) is more facile for hydrogen oxidation than the iridium-vanadium catalyst (Comparative Example 3). By far the most significant difference is the difference observed in the initial gradients of the oxidation region of each graph. In FIG. 5a, the gradient of the plot between 0 and 0.05V relating to the palladium-iridium catalyst is greater than the gradient of the iridium-vanadium plot at any given voltage. As a result, at the same potential the palladium-iridium catalyst oxidizes more oxygen (produces more current) than the iridium-vanadium catalyst. For illustration purposes, the relevant region of FIG. 5a is repeated in FIG. 5b but with an adjusted scale so as to exemplify the difference in turnover rate between the two catalysts. Also observed in FIG. 5a, is that although the limiting current data (voltages >0.1V) for the iridium-vanadium catalyst is more difficult to interpret, the palladium-iridium catalyst of the present invention exhibits no difficulty in maintaining the mass transport limiting current at the 1600 rpm rotation speed.

### Comparative Testing: Carbon Monoxide Tolerance

The electrocatalysts of the present invention have also been shown to exhibit good tolerance of carbon monoxide poisoning.

An iridium-vanadium catalyst (Comparative Example 3) was tested alongside a catalyst of the present invention (Example 1) containing iridium and palladium (palladium-iridium). In particular, the carbon monoxide tolerance of both the iridium-vanadium catalyst and the palladium-iridium catalyst were recorded.

Both catalysts were tested in 0.1M perchloric acid. Once the catalysts were in place, the catalysts were each poisoned with carbon monoxide by saturating the perchloric acid solution with carbon monoxide gas for 10 minutes. Then, anodic cyclic voltammetry was applied to the system in order to oxidise the carbon monoxide from the surface of the catalyst. The lower the potential of the oxidation, the less tightly bound the carbon monoxide is on the surface, and thus the catalyst is inherently more tolerant to carbon monoxide poisoning.

The results are shown in FIG. 6 and provide the data for the carbon monoxide-stripping peaks of both catalysts. It can be seen that the stripping peak for iridium-vanadium is at a higher voltage (0.87 V) than the palladium-iridium catalyst of the present invention (0.79 V). Fundamentally, this shows that it requires more energy to remove the carbon monoxide from the surface of the iridium-vanadium catalyst. Moreover, the iridium-vanadium peak is much broader than the stripping peak of palladium-iridium. This also suggests differences between the performance of the palladium-iridium catalyst of the present invention compared to that of the iridium-vanadium catalyst.

Pure iridium catalysts do not oxidise carbon monoxide at the potentials scanned in these tests

Furthermore, it is seen in FIG. 6 that at low potentials the iridium-vanadium catalyst is completely poisoned, but in contrast the palladium-iridium catalyst of the present invention still has sites available for hydrogen absorption/desorption, another clear indication that the catalysts employed in the present invention are more carbon monoxide-tolerant than other catalysts.

All these tests clearly demonstrate that palladium-iridium catalysts of the present invention provide different and advantageous properties compared to those known in the art.

### Comparative Testing: Oxygen Evolution Reaction Potential

The palladium-iridium electrocatalysts of the present invention have also been shown to have an additional benefit that makes their use as fuel cell anodes even more advantageous.

In fuel cells, it has been observed that the anode can cycle to high voltages during start-up and shut-down or during periods of fuel starvation. Anode potentials, which are usually between 0-0.05V versus the real hydrogen electrode during operation, can rise above 1.5V during fuel starvation events. When this happens, the anode has been seen to corrode the carbon support to sustain current. This is obviously detrimental to the ongoing effectiveness of the fuel cell system. However, catalysts or electrode additives which promote the oxygen evolution reaction in water electrolysis will split water preferentially to sustain currents during fuel starvation events thus protecting the anode electrode. FIG. 7 shows the activity of a palladium-iridium catalyst of the present invention towards oxygen evolution compared to a platinum catalyst. The lower onset potential of the palladium-iridium catalyst observed in FIG. 7 shows that it is more facile towards oxygen evolution than platinum. While platinum has almost no activity at 1.5V, the palladium-iridium catalyst already reached the onset potential for oxygen evolution. Palladium-iridium catalysts of the present invention therefore possess catalytic characteristics known in the art to be very beneficial for fuel cell system durability.

In FIG. 8, the oxygen evolution reaction activity between platinum, palladium-iridium 1:1, and palladium-iridium 3:1 is compared. Although the 3:1 ratio is slightly less facile than the 1:1 ratio, it still exhibits far greater activity than platinum. The 3:1 ratio palladium-iridium is still active at 1.5V.

The examples are for illustrative purposes, and not intended to limit the invention.

In order to address various issues and advance the aft, the entirety of this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. A fuel cell comprising:
an anode which comprises an anode electrocatalyst comprising palladium and iridium;
a cathode which comprises a cathode electrocatalyst; and
an acidic electrolyte located between the anode and the cathode; wherein the fuel cell is a hydrogen, methanol, or ethanol fuel cell.

2. A fuel cell according to claim 1, wherein the anode electrocatalyst comprises a further element.

3. A fuel cell according to claim 1, wherein the anode electrocatalyst consists of palladium and iridium.

4. A fuel cell according to claim 1, wherein the anode electrocatalyst does not contain platinum.

5. A fuel cell according to claim 1, wherein the palladium and iridium are present in the catalyst as an alloy and/or in finely-divided form.

6. A fuel cell according to claim 1, wherein the anode electrode is a diffusion electrode.

7. A fuel cell according to claim 1, wherein the cathode electrocatalyst does not contain a combination of palladium and iridium.

8. A fuel cell according to claim 1, wherein the fuel cell is a hydrogen or methanol fuel cell, preferably a hydrogen fuel cell.

9. A fuel cell stack, comprising a plurality of fuel cells as defined in claim 1, and electrical connections between them.

10. A method of generating electricity, the method comprising the steps of:
supplying fuel and an oxidant to a fuel cell as defined in claim 1, and thereby generating electricity.

11. A method according to claim 10, wherein the fuel comprises hydrogen.

12. Use of an electrocatalyst comprising palladium and iridium as an anode electrocatalyst in an acidic electrolyte fuel cell, wherein the fuel cell is a hydrogen, methanol, or ethanol fuel cell.
